(19) United States
(12) Patent Application Publication
(10) Pub. No.: US 2017/0344397 A1
(43) Pub. Date: Nov. 30, 2017

(54) DISTRIBUTING WORK IN A STREAMING APPLICATION TO COMPUTER SYSTEMS ACCORDING TO SYSTEM RESOURCES

(71) Applicant: International Business Machines Corporation, Armonk, NY (US)

(72) Inventors: Eric L. Barsness, Pine Island, MN (US); Michael J. Branson, Rochester, MN (US); Alexander Cook, Rochester, MN (US); John M. Santosuosso, Rochester, MN (US)

(21) Appl. No.: 15/166,590

(22) Filed: May 27, 2016

(51) Int. Cl. G06F 9/50; G06F 3/06; G06F 9/52

(52) U.S. Cl. CPC G06F 9/5016; G06F 9/52; G06F 3/0689; G06F 3/0604; G06F 3/0653; G06F 3/067

(57) ABSTRACT

An apparatus and method determine at runtime how to distribute work from a streaming application to multiple available computer systems based on system resources on the available computer systems, such as CPU capacity, memory capacity, storage capacity, etc. The computer systems running a streaming application can be continuously monitored, and when system resources change, portions of the streaming application can be reallocated among the computer systems according to the monitored changes in system resources.

### BACKGROUND

### 1. Technical Field

This disclosure generally relates to streaming applications, and more specifically relates to distributing work in a streaming application to available computer systems according to the system resources on the available computer systems.

### 2. Background Art

Streaming applications are known in the art, and typically include multiple processing elements coupled together in a flow graph that process streaming data in near real-time. A processing element typically takes in streaming data in the form of data tuples, operates on the data tuples in some fashion, and outputs the processed data tuples to the next processing element. Streaming applications are becoming more common due to the high performance that can be achieved from near real-time processing of streaming data.

Some streaming applications include processing elements that split the work of processing data tuples to multiple parallel processing elements. One known implementation allows the programmer to specify how the parallel processing elements are deployed to computer systems, such as two processing elements per computer system. Another known implementation allows the streams manager to determine at runtime how the processing elements are deployed to computer systems, such as deploying one processing element per computer system.

### BRIEF SUMMARY

An apparatus and method determine at runtime how to distribute work from a streaming application to multiple available computer systems based on system resources on the available computer systems, such as CPU capacity, memory capacity, storage capacity, etc. The computer systems running a streaming application can be continuously monitored, and when system resources change, portions of the streaming application can be reallocated among the computer systems according to the monitored changes in system resources.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a computer system that includes a work distribution mechanism in a streams manager that distributes work in a streaming application to a plurality of available computer systems in a computer cluster according to system resources on the computer systems;

FIG. 2 is a block diagram of a sample streaming application;

FIG. 3 is a flow diagram of a method for distributing work in a streaming application to one or more available computer systems based on system resources;

FIG. 4 is a table that shows different types of system resources that can be used in distributing work in a streaming application to available computer systems;

FIG. 5 is a table that shows sample system resource specifications for four different computer systems in a computer cluster;

FIG. 6 is a block diagram showing allocation of the six parallel processing elements D1-D6 in FIG. 2 to the four computer systems in FIG. 5 according to CPU capacity;

FIG. 7 is a block diagram showing allocation of the six parallel processing elements D1-D6 in FIG. 2 to the four computer systems in FIG. 5 according to memory capacity;

FIG. 8 is a block diagram showing allocation of the six parallel processing elements D1-D6 in FIG. 2 to the four computer systems in FIG. 5 according to storage capacity;

FIG. 9 is a flow diagram of a method for the work distribution mechanism in FIG. 1 to continuously monitor resources on the available computer systems and dynamically reallocate one or more portions of the streaming application to the available computer systems when resources change and reallocation is beneficial;

FIG. 10 is table that shows how the sample system resource specifications for the four computer systems have changed when compared to FIG. 5;

FIG. 11 is a block diagram showing allocation of the six parallel processing elements in FIG. 2 to the four computer systems in FIG. 5 according to CPU capacity with the changed system resource specifications shown in FIG. 10; and

FIG. 12 is a flow diagram of a method for logging performance of available computer systems and determining metrics that allow comparing relative performance of the available computer systems.

### DETAILED DESCRIPTION

The disclosure and claims herein are directed to determining at runtime how to distribute work from the streaming application to multiple available computer systems based on system resources on the available computer systems, such as CPU capacity, memory capacity, storage capacity, etc. The computer systems running a streaming application can be continuously monitored, and when resources change, portions of the streaming application can be reallocated among the computer systems according to the monitored changes in system resources.

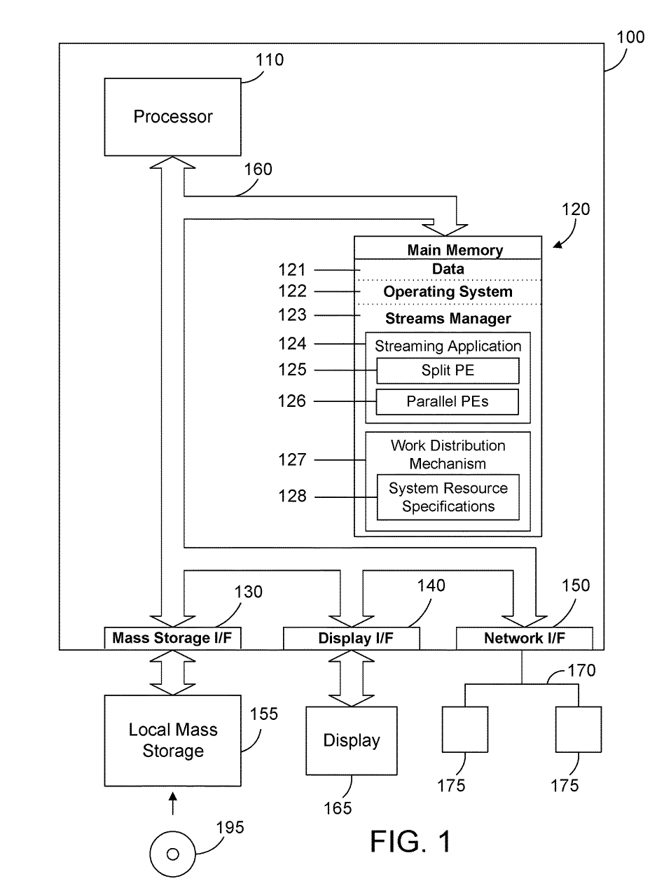

Referring to FIG. 1, a computer system 100 is one suitable implementation of a server computer system that includes a work distribution mechanism in a streams manager as described in more detail below. Server computer system 100 is an IBM POWER8 computer system. However, those skilled in the art will appreciate that the disclosure herein applies equally to any computer system, regardless of whether the computer system is a complicated multi-user computing apparatus, a single user workstation, a laptop computer system, a tablet computer, a phone, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as local mass storage device 155, to computer system 100. One specific type of local mass storage device 155 is a readable and writable CD-RW drive, which may store data to and read data from a CD-RW 195. Another suitable type of local mass storage device 155 is a card reader that receives a removable memory card, such as an SD card, and performs reads and writes to the removable memory. Yet another suitable type of local mass storage device 155 is a thumb drive.

Main memory 120 preferably contains data 121, an operating system 122, and a streams manager 123. Data 121 represents any data that serves as input to or output from any program in computer system 100. Operating system 122 is a multitasking operating system, such as AIX or LINUX. The streams manager 123 is software that provides a run-time environment that executes a streaming application 124. The streaming application 124 preferably comprises a flow graph that includes processing elements that include operators that process data tuples. The streaming application 124 includes one or more split processing elements 125 that each routes incoming data tuples to multiple parallel processing elements 126 that process in parallel data tuples received from the split processing element 125. In the prior art, the decision of where to deploy the parallel processing elements 126 is one that is made statically by the programmer or is made at runtime according to some predetermined criteria, such as evenly dividing the processing elements to the available computer systems. The prior art does not decide where to deploy the parallel processing elements based on the system resources in the available computer systems.

The streams manager 123 includes a work distribution mechanism 127 that dynamically determines are runtime where to deploy the parallel processing elements 126 that receive data from the split processing element 125 according to system resources on the available computer systems. The work distribution mechanism 127 reads system resource specifications 128 that preferably include a specification of system resources of interest in each available computer system in a computer cluster. The system resource specifications 128 can be compiled in any suitable way. For example, the work distribution mechanism 127 could query each available computer system in the computer cluster for the available resources, then log that information as the system resource specifications 128. In the alternative, some other software could compile the system resource specifications 128 and make these available to the work distribution mechanism 127. The work distribution mechanism 127 determines at runtime how to distribute work from the streaming application to multiple available computer systems based on system resources on the available computer systems, such as CPU capacity, memory capacity, storage capacity, etc. In one suitable implementation, the distribution of work means the work distribution mechanism 127 deploys one or more parallel processing elements 126 in the streaming application to multiple available computer systems in a computer cluster based on the system resources in each computer system, as explained in more detail below. The work distribution mechanism 127 is shown in FIG. 1 as part of the streams manager 123 as one possible implementation. One skilled in the art will recognize the work distribution mechanism 127 could be software separate from the streams manager 123 that interacts with the streams manager 123.

Computer system 100 utilizes well known virtual addressing mechanisms that allow the programs of computer system 100 to behave as if they only have access to a large, contiguous address space instead of access to multiple, smaller storage entities such as main memory 120 and local mass storage device 155. Therefore, while data 121, operating system 122, and streams manager 123 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Processor 110 also executes the streams manager 123, which executes the streaming application 124, which includes the work distribution mechanism 127.

Although computer system 100 is shown to contain only a single processor and a single system bus, those skilled in the art will appreciate that a work distribution mechanism in a streaming application as described herein may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Computer systems 175 represent computer systems that are connected to the computer system 100 via the network interface 150 in a computer cluster. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allows communicating on the network 170. Software in the network interface 150 preferably includes a communication manager that manages communication with other computer systems 175 via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 150. In one suitable implementation, the network interface 150 is a physical Ethernet adapter.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

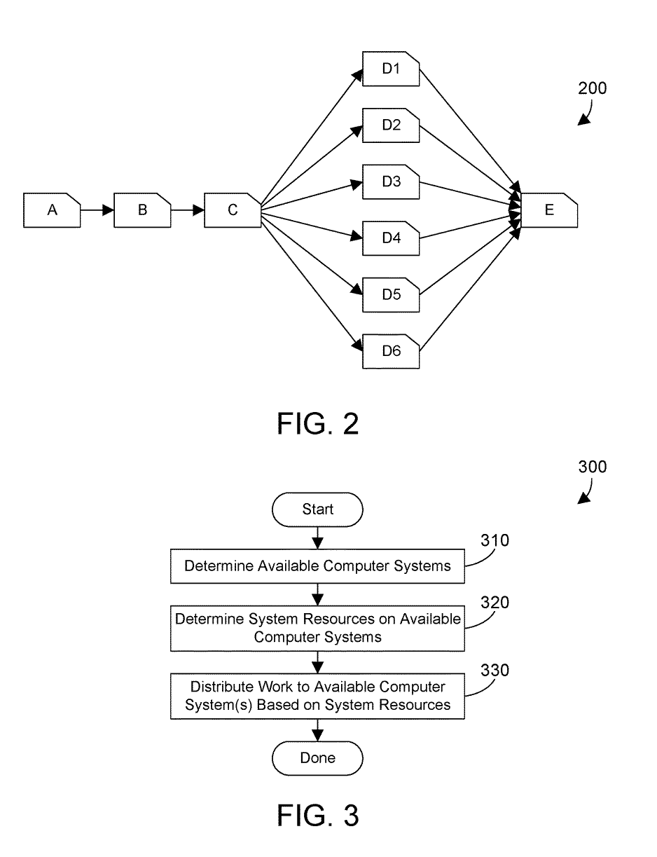

Referring to FIG. 2, an extremely simplified streaming application 200 is shown for the purposes of illustrating the concepts herein. The streaming application 200 includes ten processing elements A, B, C, D1-D6 and E. Processing element A produces data tuples that are sent to processing element B. Processing element B operates on the data tuples received from processing element A and sends the resulting data tuples to processing element C. Processing element C is a processing element that splits the data tuples received from processing element B, and sends these data tuples to six parallel operators D1-D6. Processing element C in FIG. 2 is one suitable example of the split processing element 125 in FIG. 1, and processing elements D1-D6 are suitable examples of the parallel processing elements 126 in FIG. 1. The tuples produced by processing elements D1-D6 are then sent to processing element E.

In the prior art, the decision of which of the parallel processing elements D1-D6 to deploy on available computer systems is either a static decision made by the programmer in the code, or is a runtime decision based on some predetermined criteria, such as splitting the parallel operators evenly among the available computer systems. The work distribution mechanism disclosed herein, in contrast, deploys the parallel processing elements D1-D6 onto available computer systems based on the resources on the available computer systems.

Referring to FIG. 3, a method 300 is preferably performed by the work distribution mechanism 127 in FIG. 1. The available computer systems in the computer cluster are determined (step 310). The system resources on the available computer systems are determined (step 320). The work is then distributed to one or more of the available computer systems based on the system resources determined in step 320 (step 330). Method 300 is then done. In one suitable implementation, the work distribution mechanism 127 performs all the steps 310, 320 and 220 in FIG. 3. In an alternative implementation, steps 310 and/or 320 may be performed by other software to generate the system resource specifications 128 in FIG. 1, while step 330 is performed by the work distribution mechanism 127.

How the distribution of work in the streaming application in step 330 to one or more of the available computer systems is done depends on the streaming application and streams manager being used. For example, if the streams manager is InfoSphere Streams by IBM, with the addition of the work distribution mechanism disclosed herein, the distribution of work in step 330 will include deploying one or more processing elements or operators to different computer systems. Other streams manager may use different representations than processing elements in flow graphs. Step 330 broadly includes deploying any portion of a streaming application to one or more of the available computer systems in a computer cluster, regardless of the specific terminology used.

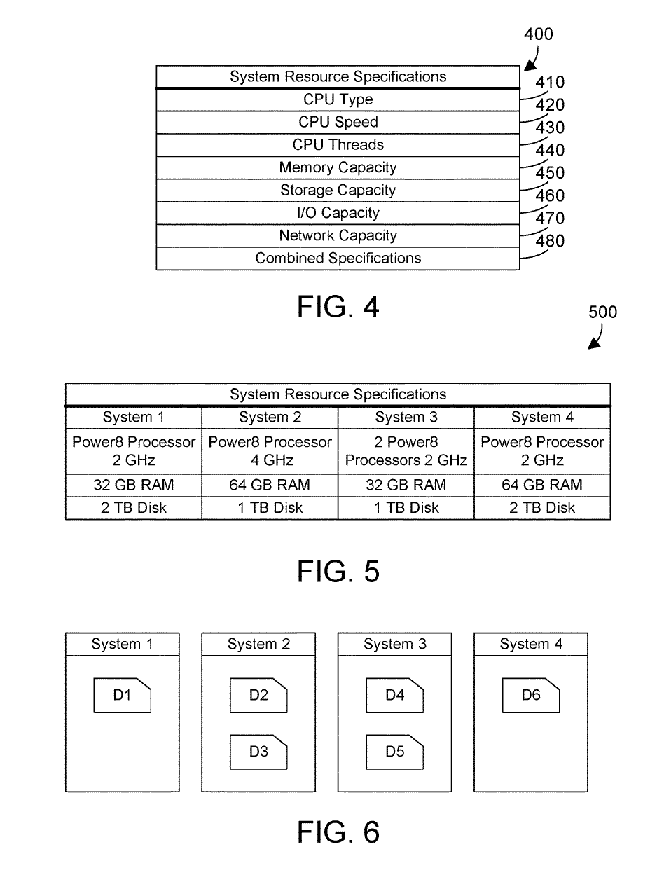

FIG. 4 shows a table 400 with some possible categories within the system resource specifications. Table 400 thus represents one suitable implementation of the system resource specifications 128 shown in FIG. 1. System resource specifications 400 in FIG. 4 may include any or all of the following: CPU type 410; CPU speed 420; CPU threads 430; memory capacity 440; storage capacity 450; I/O capacity 460; network capacity; and combined specifications 470. Combined specifications 470 may include any suitable combination of other system resource specifications, such as those shown at 410-470 in FIG. 4.

Some simple examples are now provided to illustrate the function of the work distribution mechanism 127 in FIG. 1. We assume a computer cluster has a total of five computer systems, with the first being computer system 100 in FIG. 1 that runs the streams manager, and the other four computer systems being available computer systems in the same computer cluster as computer system 100. System resource specifications 500 for the four available computer systems in the computer cluster are shown at 500 in FIG. 5. The system resource specifications 500 in FIG. 5 shows that System 1 includes one Power8 processor running at 2 GHz, 32 GB of RAM, and a 2 TB disk. System 2 in FIG. 5 includes one Power8 processor running at 4 GHz, 64 GB of RAM, and a 1 TB disk. System 3 in FIG. 5 includes 2 Power8 processors running at 2 GHz, 32 GB of RAM, and a 1 TB disk. System 4 in FIG. 5 includes one Power8 processor running at 2 GHz, 64 GB of RAM, and a 2 TB disk.

We now assume the six parallel processing elements D1-D6 need to be deployed to the four available computer systems shown in FIG. 5. We further assume the work distribution mechanism 127 determines to distribute the parallel processing elements according to CPU capacity. We make the simplistic assumption for this example that two Power8 processors process data twice as fast as one Power8 processor at the same clock speed, and that a Power8 processor operating at twice a specified clock speed processes data twice as fast as a Power8 processor operating at the specified clock speed. With these assumptions, we assume that a Power8 processor operating at 2 GHz represents one unit of CPU capacity. This means System 1 has one unit of CPU capacity; System 2 has two units of CPU capacity; System 3 had two units of CPU capacity; and System 4 has one unit of CPU capacity. With a total of six units of CPU capacity across the four systems, the work distribution mechanism can deploy the six parallel processing elements D1-D6 on a one-to-one basis to the six units of CPU capacity. This means one parallel processing element is deployed to System 1; two parallel processing elements are deployed to System 2; two parallel processing elements are deployed to System 3; and one parallel processing elements is deployed to System 4. FIG. 6 shows one suitable example for the work distribution mechanism to distribute the six parallel processing elements D1-D6 across the four available computer systems in the cluster based on CPU capacity. Note the specific arrangement of parallel processing elements in the four available computer systems can vary. In other words, processing element D4 could be deployed to System 1. The example in FIG. 6 shows the number of processing elements deployed to each available computer system, and which specific processing elements are deployed to which specific computer systems in unimportant. [Correct?]

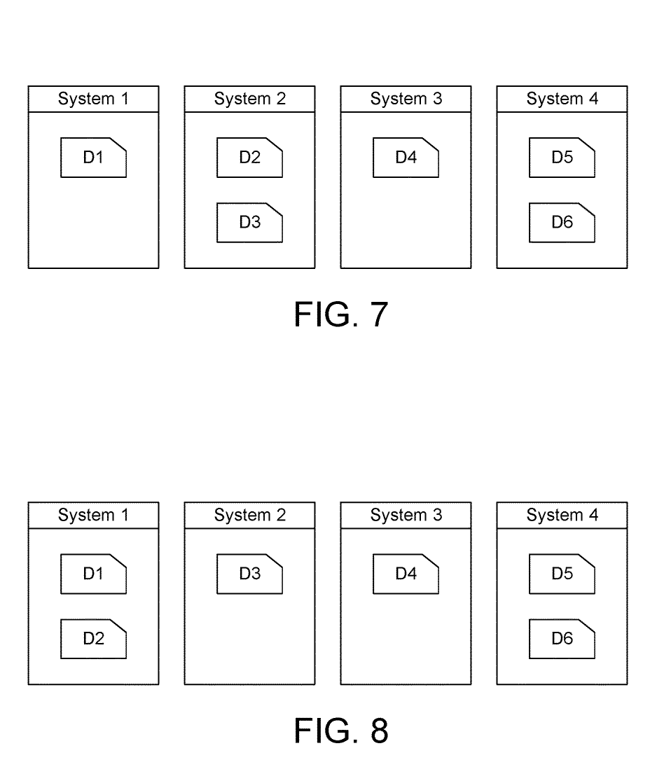

In the next example, we assume the same six parallel processing elements D1-D6 need to be deployed to the four computer systems shown in FIG. 5, but this time the work distribution mechanism 127 determines to distribute the parallel processing elements according to memory capacity instead of CPU capacity. We assume 32 GB or RAM represents one unit of memory. This means System 1 has one unit of memory; System 2 has two units of memory; System 3 had one unit of memory; and System 4 has two units of memory. With a total of six units of memory capacity across the four systems, the work distribution mechanism can deploy the six parallel processing elements D1-D6 on a one-to-one basis to the six units of memory capacity. This means one parallel processing element is deployed to System 1; two parallel processing elements are deployed to System 2; one parallel processing element is deployed to System 3; and two parallel processing elements are deployed to System 4. FIG. 7 shows one suitable example for the work distribution mechanism to distribute the six parallel processing elements D1-D6 across the four available computer systems in the cluster based on memory capacity. Once again, the specific arrangement of parallel processing elements in the four available computer systems can vary, which means any suitable processing element can be deployed to any suitable computer system, as long as the number of processing elements in the computer systems remains as represented in FIG. 7.

In the next example, we assume the same six parallel processing elements D1-D6 need to be deployed to the four computer systems shown in FIG. 5, but this time the work distribution mechanism 127 determines to distribute the parallel processing elements according to disk capacity. We assume 1 TB represents one unit of disk capacity. This means System 1 has two units of disk capacity; System 2 has one unit of disk capacity; System 3 had one unit of disk capacity; and System 4 has two units of disk capacity. With a total of six units of disk capacity across the four systems, the work distribution mechanism can deploy the six parallel processing elements D1-D6 on a one-to-one basis to the six units of disk capacity. This means two parallel processing elements are deployed to System 1; one parallel processing element is deployed to System 2; one parallel processing element is deployed to System 3; and two parallel processing elements are deployed to System 4. FIG. 8 shows one suitable example for the work distribution mechanism to distribute the six parallel processing elements D1-D6 across the four available computer systems in the cluster based on disk capacity. Once again, the specific arrangement of parallel processing elements in the four available computer systems can vary, which means any suitable processing element can be deployed to any suitable computer system, as long as the number of processing elements in the computer systems remains as represented in FIG. 8.

The examples provided herein are extremely simplified to illustrate the general concepts of deploying parallel processing elements to multiple computer systems based on system resources in the computer systems. In practice, the number of resources in the computer systems may not provide an exact multiple of the number of parallel processing elements that need to be deployed. In this case, the work distribution mechanism does the best it can based on the number of resources in the computer systems and the number of parallel processing elements that need to be deployed. Furthermore, while the three examples in FIGS. 6-8 show deploying the parallel processing elements based on CPU capacity, memory capacity, and disk capacity, respectively, other cases that use CPU threads, I/O capacity, and/or network capacity and/or configuration are within the scope of the disclosure and claims herein. Furthermore, instead of using a single resource as the deciding factor as illustrated in FIGS. 6-8, the work distribution mechanism could use any suitable combination of resources in determining where to deploy the parallel processing elements on the available computer systems. Furthermore, the deployment of parallel processing elements to multiple computer system can be done initially based on some criteria, then can be adjusted based on system resources as described above. For example, two processing elements could initially be deployed to each of the four computer systems in FIGS. 6-8 so each computer system has processing elements that are ready to run. The streams manager could then determine based on system resources that only six of the eight processing elements will be used, as shown in FIGS. 6-8. In the alternative, the streams manager could initially deploy two processing elements to each of the four computer systems in FIGS. 6-8, and the split operator could then distribute tuples to only six of the eight processing elements based on resource allocation. These and other variations are within the scope of the disclosure and claims herein.

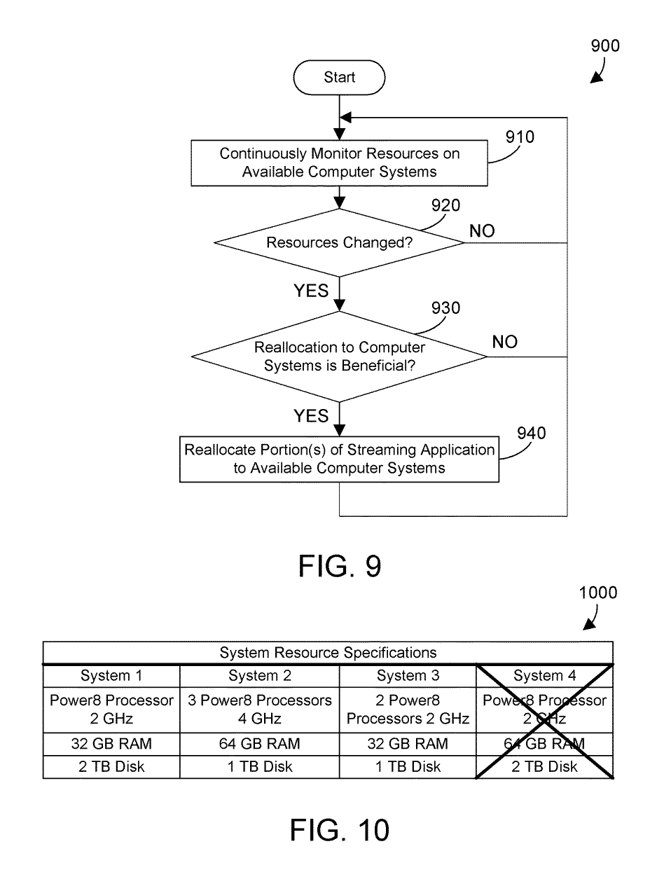

The work distribution mechanism 127 not only makes an initial deployment of processing elements to computer systems based on system resources, but it can also continuously monitor resources available on the computer systems and make adjustments as needed. Referring to FIG. 9, method 900 is preferably performed by the work distribution mechanism 127 in FIG. 1. The resources on the available computer systems in the computer cluster are continuously monitored (step 910). As long as the resources have not changed (step 920=NO), method 900 loops back to step 910. Once a change in the resources is detected (step 920=YES), method 900 determines whether reallocation of one or more portions of the streaming application to the computer systems would be beneficial (step 930). When the reallocation would not be beneficial (step 930=NO), method 900 loops back to step 910 and continues. When the reallocation would be beneficial (step 930=YES), one or more portions of the streaming application are reallocated to the available computer systems (step 940). This continuous monitoring and adjusting depicted in method 900 in FIG. 9 makes the work distribution mechanism 127 extremely powerful and flexible, because it can adjust to changes in the system resources on the systems. A simple example will illustrate.

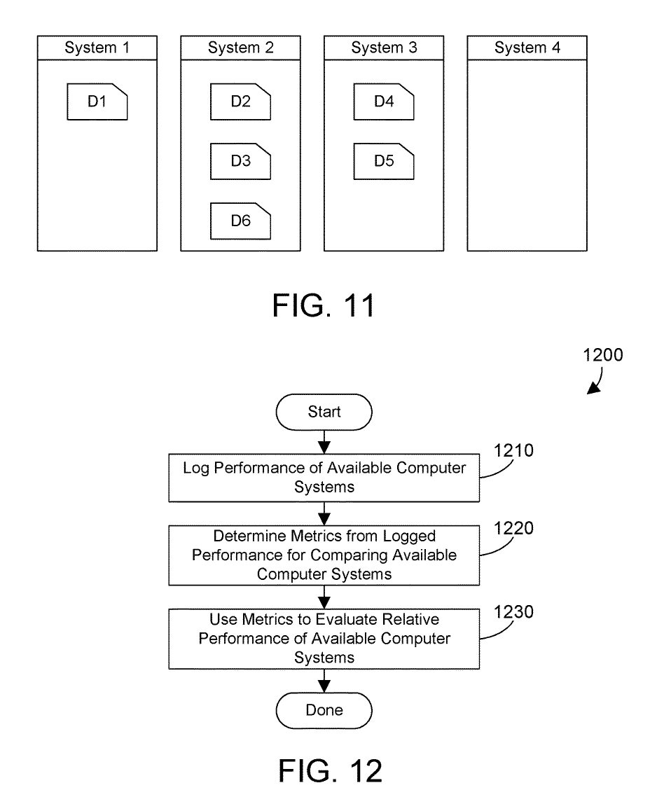

We assume for this example the system resource specifications 400 in FIG. 4 change to that shown at 1000 in FIG. 10. There are two changes to note. Two more Power8 processors running at 4 GHs have been added to System 2. In addition, System 4 is no longer available, as shown by the X through System 4 in FIG. 10. This could occur, for example, due to a hardware failure in System 4, or due to System 4 being taken down by a system administrator for maintenance. With these two changes in CPU capacity shown in FIG. 10, the work distribution mechanism could deploy the parallel processing element D6 that was formerly deployed on System 4 to System 2 instead, as shown in FIG. 11. This simple example illustrates how the work distribution mechanism disclosed and claimed herein can continuously adjust for a changing number of system resources in the available systems, thereby dynamically optimizing performance of the streaming application at runtime.

The examples given above used some very simple assumptions, such as a Power8 processor running at 4 GHz processes twice as fast as a Power8 processor running at 2 GHz, and that 64 GB of RAM gives twice the performance as 32 GB of RAM. In reality, these simple assumptions are not accurate because it is the combination of system resources that determines system performance. Method 1200 in FIG. 12 shows how the work distribution mechanism can account for these combinations of resources. The performance of the available computer systems is logged (step 1210). In one suitable implementation, the same test code is run on all of the available computer systems so their relative performance can be logged in step 1210. Determine metrics from the logged performance for comparing the available computer systems (step 1220). These metrics determined in step 1220 can then be used to evaluate relative performance of the available computer systems (step 1230). In this manner, method 1200 gives the work distribution mechanism more intelligence about how to deploy portions of a streaming application to different computer systems based on actual logged performance instead of estimates.

An apparatus and method determine at runtime how to distribute work from a streaming application to multiple available computer systems based on system resources on the available computer systems, such as CPU capacity, memory capacity, storage capacity, etc. The computer systems running a streaming application can be continuously monitored, and when system resources change, portions of the streaming application can be reallocated among the computer systems according to the monitored changes in system resources.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a network interface coupled to the at least one processor that connects the apparatus to a plurality of computer systems in a computer cluster;
a streams manager residing in the memory and executed by the at least one processor, the streams manager executing a streaming application that comprises a flow graph that includes a plurality of processing elements that process a plurality of data tuples, wherein the plurality of processing elements includes a split processing element that distributes incoming data tuples to a plurality of parallel processing elements; and
a work distribution mechanism that deploys the plurality of parallel processing elements to the plurality of computer systems in the computer cluster based on system resource specifications that indicate system resources on the plurality of computer systems.

2. The apparatus of claim 1 wherein the system resource specifications include CPU capacity, memory capacity and disk capacity for the plurality of computer systems.

3. The apparatus of claim 2 wherein the work distribution mechanism deploys the plurality of parallel processing elements to the plurality of computer systems in the computer cluster based on CPU capacity for the plurality of computer systems.

4. The apparatus of claim 2 wherein the work distribution mechanism deploys the plurality of parallel processing elements to the plurality of computer systems in the computer cluster based on memory capacity for the plurality of computer systems.

5. The apparatus of claim 2 wherein the work distribution mechanism deploys the plurality of parallel processing elements to the plurality of computer systems in the computer cluster based on disk capacity for the plurality of computer systems.

6. The apparatus of claim 2 wherein the CPU capacity includes CPU threads and the system resource specifications further includes Input/Output (I/O) capacity for each of the plurality of computer systems.

7. The apparatus of claim 1 wherein the work distribution mechanism monitors at runtime the plurality of computer systems for changes in the system resources, and when changes in the system resources occur that would make reallocation of the plurality of parallel processing elements beneficial, the work distribution mechanism reallocates the plurality of parallel processing elements to the plurality of computer systems based on the changes.

8. The apparatus of claim 1 wherein the work distribution mechanism monitors and logs performance of the plurality of computer systems when running test code, generates from the logged performance metrics for comparing the plurality of computer systems, and uses the metrics to evaluate relative performance of the plurality of computer systems when deploying the plurality of processing elements to the plurality of computer systems.

9. A computer-implemented method executed by at least one processor for running streaming applications, the method comprising:
executing a streams manager that executes a streaming application that comprises a flow graph that includes a plurality of processing elements that process a plurality of data tuples, wherein the plurality of processing elements includes a split processing element that distributes incoming data tuples to a plurality of parallel processing elements; and
deploying the plurality of parallel processing elements to a plurality of computer systems in a computer cluster based on system resource specifications that indicate system resources on the plurality of computer systems.

10. The method of claim 9 wherein the system resource specifications include CPU capacity, memory capacity and disk capacity for the plurality of computer systems.

11. The method of claim 10 wherein the deploying the plurality of parallel processing elements to the plurality of computer systems in the computer cluster is based on CPU capacity for the plurality of computer systems.

12. The method of claim 10 wherein the deploying the plurality of parallel processing elements to the plurality of computer systems in the computer cluster is based on memory capacity for the plurality of computer systems.

13. The method of claim 10 wherein the deploying the plurality of parallel processing elements to the plurality of computer systems in the computer cluster is based on disk capacity for the plurality of computer systems.

14. The method of claim 10 wherein the CPU capacity includes CPU threads and the system resource specifications further includes Input/Output (I/O) capacity for each of the plurality of computer systems.

15. The method of claim 9 further comprising:
monitoring at runtime the plurality of computer systems for changes in the system resources; and
when changes in the system resources occur that would make reallocation of the plurality of parallel processing elements beneficial, reallocating the plurality of parallel processing elements to the plurality of computer systems based on the changes.

16. The method of claim 9 further comprising:
logging performance of the plurality of computer systems when running test code;
generating from the logged performance metrics for comparing the plurality of computer systems; and
using the metrics to evaluate relative performance of the plurality of computer systems when deploying the plurality of processing elements to the plurality of computer systems.

17. A computer-implemented method executed by at least one processor for running streaming applications, the method comprising:
executing a streams manager that executes a streaming application that comprises a flow graph that includes a plurality of processing elements that process a plurality of data tuples, wherein the plurality of processing elements includes a split processing element that distributes incoming data tuples to a plurality of parallel processing elements;
deploying the plurality of parallel processing elements to a plurality of computer systems in a computer cluster based on system resource specifications that indicate CPU capacity, memory capacity and disk capacity for the plurality of computer systems;
logging performance of the plurality of computer systems when running test code;
generating from the logged performance metrics for comparing the plurality of computer systems;
using the metrics to evaluate relative performance of the plurality of computer systems when deploying the plurality of processing elements to the plurality of computer systems;
monitoring at runtime the plurality of computer systems for changes in the system resources; and
when changes in the system resources occur that would make reallocation of the plurality of parallel processing elements beneficial, reallocating the plurality of parallel processing elements to the plurality of computer systems based on the changes.

18. The method of claim 17 wherein the deploying the plurality of parallel processing elements to the plurality of computer systems in the computer cluster is based on CPU capacity for the plurality of computer systems.

19. The method of claim 17 wherein the deploying the plurality of parallel processing elements to the plurality of computer systems in the computer cluster is based on memory capacity for the plurality of computer systems.

20. The method of claim 17 wherein the deploying the plurality of parallel processing elements to the plurality of computer systems in the computer cluster is based on disk capacity for the plurality of computer systems.
